(19) United States
(12) Patent Application Publication
(10) Pub. No.: US 2024/0209120 A1
(43) Pub. Date: Jun. 27, 2024

(54) METHOD OF PREPARING LITHIUM SALT OF CARBOXYMETHYL CELLULOSE AND RECHARGEABLE LITHIUM BATTERY COMPRISING LITHIUM SALT OF CARBOXYMETHYL CELLULOSE PREPARED BY SAME

(71) Applicant: SAMSUNG SDI CO., LTD., Yongin-si (KR)

(72) Inventors: Yunshik CHO, Yongin-si (KR); Minho CHO, Yongin-si (KR); Hana KIM, Yongin-si (KR); Jungmin LEE, Yongin-si (KR); Kukjoo LEE, Yongin-si (KR); Kyunghwa JUNG, Yongin-si (KR)

(21) Appl. No.: 18/481,918

(22) Filed: Oct. 5, 2023

(30) Foreign Application Priority Data
Dec. 16, 2022 (KR) 10-2022-0177250

(51) Int. Cl. C08B 11/145; H01M 4/13; H01M 4/62; H01M 10/052

(52) U.S. Cl. CPC C08B 11/145; H01M 4/13; H01M 4/622; H01M 10/052

(57) ABSTRACT

A method of preparing a lithium salt of carboxymethyl cellulose is provided. The method includes carrying out alkalization of cellulose in the presence of lithium hydroxide to generate an alkali product; and mixing the resulting product with a halogenated (e.g., halogen-including) acetic acid or a salt thereof to carry out etherification. An amine derivative is added to at least one of the alkalization or etherification.

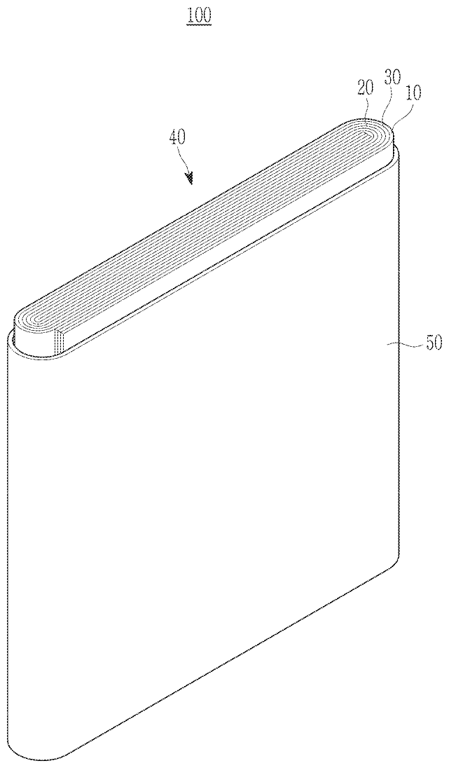

### CROSS-REFERENCE TO RELATED APPLICATION

This application claims priority to and the benefit of Korean Patent Application No. 10-2022-0177250, filed in the Korean Intellectual Property Office on Dec. 16, 2022, the entire content of which is incorporated herein by reference.

### BACKGROUND

### 1. Field

According to one or more embodiments, the present disclosure relates to a method of preparing a lithium salt of carboxymethyl cellulose and a rechargeable lithium battery including the lithium salt of carboxymethyl cellulose prepared by the method.

### 2. Description of the Related Art

Recently, the rapid change of electronic devices such as mobile phones, laptop computers, and electric vehicles toward utilizing batteries requires (or causes) surprising increases in demand for rechargeable batteries with relatively high capacity and lighter weight. For example, a rechargeable lithium battery has recently drawn attention as a driving power source for portable devices, as it has lighter weight and high energy density. Accordingly, research for improving the performance of rechargeable lithium batteries is actively being conducted.

Carboxymethyl cellulose is one of the representative polymers for increasing viscosity utilized in rechargeable lithium batteries. Carboxymethyl cellulose is generally utilized in the form substituted with an alkali salt. For example, the form substituted with sodium is suitable for the aqueous system, and thus, it is mainly utilized. However, recently, sodium has been associated with electrochemical side reactions in the battery, and thus, studies have been actively undertaken to utilize carboxymethyl cellulose substituted with lithium, instead of sodium.

The implementation of lithium salt of carboxymethyl cellulose, however, is uneconomical due to its complicated preparation. Therefore, it is desirable to provide a method of preparing a lithium salt of carboxymethyl cellulose for utilization in a rechargeable lithium battery.

### SUMMARY

One or more aspects are directed toward a method of preparing a lithium salt of carboxymethyl cellulose utilizing a simple process, which is capable of giving a high yield.

One or more e aspects are directed toward a rechargeable lithium battery including a negative electrode including the lithium salt of carboxymethyl cellulose prepared by the method, a positive electrode, and an electrolyte.

One or more embodiments provide a method of preparing a lithium salt of carboxymethyl cellulose, including carrying out alkalization of cellulose and lithium hydroxide to prepare an alkali product; and mixing the alkali product with a halogenated (e.g., halogen-including) acetic acid, or a salt thereof, to carry out an etherification, wherein an amine derivative is added to at least one of the alkalization or the etherification.

The amine derivative may be represented by Chemical Formula 1 or Chemical Formula 2.

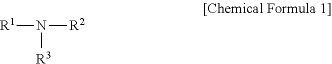

In Chemical Formula 1, R¹, R², and R³ may each independently be the same or different, and are hydrogen, or an unsubstituted or halogen-substituted C1-C12 alkyl group.

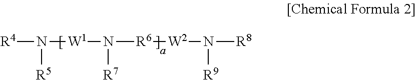

In Chemical Formula 2, R⁴, R⁵, R⁷, R⁸, and R⁹ may each independently be the same or different, and are hydrogen, or an unsubstituted or halogen-substituted C1-C12 alkyl group,

R⁶ may a C1-C12 alkenyl group,

W¹ and W² may each independently be the same or different and are a C1 to C12 alkenyl group, and

a is an integer of about 0 to about 2.

In one embodiment, the amine derivative may be dimethylamine, diethylamine, trimethylamine, triethylamine, chloroalkyl amine, bromoalkyl amine, bis(chloro alkyl)amine, tris(chloro alkyl)amine, ethylene diamine, diethylene triamine, triethylene tetraamine, or combinations thereof.

The halogenated (e.g., halogen-including) acetic acid may be chloroacetic acid, fluoroacetic acid, bromoacetic acid, iodineacetic acid, or combinations thereof.

The salt of the halogenated (e.g., halogen-including) acetic acid may be a lithium salt of the halogenated (e.g., halogen-including) acetic acid.

An added amount of the amine derivative may be about 0.0001 parts by weight to 100 parts by weight based on about 1 part by weight of the cellulose.

The halogenated (e.g., halogen-including) acetic acid or the salt thereof may be added at an amount of about 0.1 parts by weight to about 100 parts by weight based on 1 part of the cellulose.

The lithium salt of carboxymethyl cellulose may have a degree of substitution of about 0.5 or more and about 1.5 or less.

The alkalization may be carried out in a solvent. Herein, the solvent may be water, alcohol, or combinations thereof.

Another embodiment provides a rechargeable lithium battery including a negative electrode including the lithium salt of carboxymethyl cellulose prepared by the method, a positive electrode, and an electrolyte.

A method of preparing a lithium salt of carboxymethyl cellulose according to one embodiment is simple, and may prepare the lithium salt of carboxymethyl cellulose with a high yield.

### BRIEF DESCRIPTION OF THE DRAWING

The drawing is a schematic diagram showing a negative electrode for a rechargeable lithium battery according to one or more embodiments.

### DETAILED DESCRIPTION

Hereinafter, embodiments of the present disclosure are described in more detail with reference to the accompanying drawing. However, these embodiments are merely examples, the present disclosure is not limited thereto, and the present disclosure is defined by the scope of claims. The present disclosure may be modified in many alternate forms, and is intended to cover all modifications, equivalents, and alternatives falling within the spirit and scope of the present disclosure.

The terminology utilized herein describes embodiments only, and is not intended to limit the present disclosure. The singular expression includes the plural expression unless the context clearly dictates otherwise. Unless otherwise defined, all chemical names, technical and scientific terms, and terms defined in common dictionaries should be interpreted as having meanings consistent with the context of the related art, and should not be interpreted in an ideal or overly formal sense. It will be understood that, although the terms first, second, etc. may be used herein to describe various elements, these elements should not be limited by these terms. These terms are only used to distinguish one element from another element. Thus, a first element could be termed a second element without departing from the teachings of the present disclosure. Similarly, a second element could be termed a first element.

### Definitions

The term “combination thereof may include a mixture, a laminate, a complex, a copolymer, an alloy, a blend, a reactant of constituents.

The terms “comprises,” “comprising,” “comprise,” “includes,” “including,” “include” “having,” “has,” and/or “have” are intended to designate that the performed characteristics, numbers, steps, constituted elements, or a combination thereof are present, but it should be understood that the possibility of presence or addition of one or more other characteristics, numbers, steps, constituted element, or a combination do not be precluded in advance.

As used herein, singular forms such as “a,” “an,” and “the” are intended to include the plural forms as well, unless the context clearly indicates otherwise.

As used herein, the terms “use,” “using,” and “used” may be considered synonymous with the terms “utilize,” “utilizing,” and “utilized,” respectively.

As used herein, expressions such as “at least one of,” “one of,” and “selected from,” if (e.g., when) preceding a list of elements, modify the entire list of elements and do not modify the individual elements of the list. For example, the expressions “at least one of a to c,” “at least one of a, b or c,” and “at least one of a, b and/or c” may indicate only a, only b, only c, both (e.g., simultaneously) a and b, both (e.g., simultaneously) a and c, both (e.g., simultaneously) b and c, all of a, b, and c, or variations thereof.

As used herein, the term “and/or” includes any and all combinations of one or more of the associated listed items.

The term “may” will be understood to refer to “one or more embodiments of the present disclosure,” some of which include the described element and some of which exclude that element and/or include an alternate element. Similarly, alternative language such as “or” refers to “one or more embodiments of the present disclosure,” each including a corresponding listed item.

It will be understood that if (e.g., when) an element is referred to as being “on,” “connected to,” or “coupled to” another element, it may be directly on, connected, or coupled to the other element or one or more intervening elements may also be present. If (e.g., when) an element is referred to as being “directly on,” “directly connected to,” or “directly coupled to” another element, there are no intervening elements present.

Spatially relative terms, such as “beneath,” “below,” “lower,” “above,” “upper,” “bottom,” “top,” and the like, may be used herein for ease of description to describe one element or feature's relationship to another element(s) or feature(s) as illustrated in the drawings. It will be understood that the spatially relative terms are intended to encompass different orientations of the device in use or operation in addition to the orientation depicted in the drawings. For example, if the device in the drawings is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

Unless otherwise defined, all terms (including technical and scientific terms) used herein have the same meaning as commonly understood by those of ordinary skill in the art to which the present disclosure pertains. It is also to be understood that terms defined in commonly used dictionaries should be interpreted as having meanings consistent with meanings in the context of the related art, unless expressly defined herein, and should not be interpreted in an ideal or overly formal sense.

In this context, “consisting essentially of” means that any additional components will not materially affect the chemical, physical, optical or electrical properties of the semiconductor film.

Further, in this specification, the phrase “on a plane,” or “plan view,” means viewing a target portion from the top, and the phrase “on a cross-section” means viewing a cross-section formed by vertically cutting a target portion from the side.

In the drawing, the thickness of layers, films, panels, regions, etc., are exaggerated for clarity and like reference numerals designate like elements throughout, and duplicative descriptions thereof may not be provided in the specification. It will be understood that if (e.g., when) an element such as a layer, film, region, or substrate is referred to as being “on” another element, it can be directly on the other element or intervening elements may also be present. In contrast, if (e.g., when) an element is referred to as being “directly on” another element, there are no intervening elements present.

In some embodiments, “layer” as utilized herein includes not only a shape formed on the whole surface if (e.g., when) viewed from a plan view, but also a shape formed on a partial surface.

In some embodiments, the terms “about” and “substantially” utilized throughout the present specification refer to the meaning of the mentioned with inherent preparation and material permissible errors if (e.g., when) presented, and are utilized in the sense of being close to or near that value. They are utilized to help understand the present disclosure and to prevent or reduce unconscientious infringers from unfairly exploiting the disclosure where accurate or absolute values are mentioned.

In the specification, “A and/or B” indicates “A or B or both (e.g., simultaneously) of them.”

If (e.g., when) a definition is not otherwise provided in the specification, an average particle diameter indicates an average particle diameter (D50) where a cumulative volume is about 50 volume % in a particle distribution. The average particle diameter (D50) may be measured by a method well suitable to those skilled in the art, for example, by a particle size analyzer, or by a transmission electron microscopic image, a scanning electron microscopic, or field emission scanning electron microscopy (FE-SEM). In some embodiments, a dynamic light-scattering measurement device is utilized to perform a data analysis, and the number of particles is counted for each particle size range, and from this, the average particle diameter (D50) value may be easily obtained through a calculation. In the present disclosure, when particles are spherical, “diameter” indicates a particle diameter or an average particle diameter, and when the particles are non-spherical, the “diameter” indicates a major axis length or an average major axis length.

As utilized herein, if (e.g., when) a definition is not otherwise provided, “substituted” refers to replacement of hydrogen of a compound by a substituent selected from among a deuterium, a halogen, a hydroxyl group, an amino group, a substituted or unsubstituted C1 to C30 amine group, a nitro group, a substituted or unsubstituted C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C20 alkoxy group, a C1 to C10 fluoroalkyl group, a cyano group, and/or combinations thereof.

As utilized herein, if (e.g., when) a definition is not otherwise provided, “substituted” refers to replacement of at least one hydrogen of a substituent or a compound by deuterium, a halogen, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. In some embodiments, in some examples of the present disclosure, “substituted” refers to replacement of at least one hydrogen of a substituent or a compound by deuterium, a halogen, a C1 to C20 alkyl group, a C6 to C30 aryl group, a C1 to C10 fluoroalkyl group, or a cyano group. In some embodiments, in some examples of the present disclosure, “substituted” refers to replacement of at least one hydrogen of a substituent or a compound by deuterium, a halogen, a C1 to C5 alkyl group, a C6 to C18 aryl group, a C1 to C5 fluoroalkyl group, or a cyano group. In some embodiments, in specific examples of the present disclosure, “substituted” refers to replacement of at least one hydrogen of a substituent or a compound by deuterium, a cyano group, a halogen, a methyl group, an ethyl group, a propyl group, a butyl group, a phenyl group, a biphenyl group, a terphenyl group, a trifluoromethyl group, or a naphthyl group.

Expressions such as C1 to C30 refer to that the number of carbon atoms is 1 to 30.

### Method

A method of preparing a lithium salt of carboxymethyl cellulose according to one or more embodiments includes that cellulose and lithium hydroxide are mixed and/or contacted to carry out an alkalization (e.g., alkalization reaction) to generate an alkali product. The method includes that the resulting alkali product is mixed and/or contacted with a halogenated (e.g., halogen-including) acetic acid or a salt thereof to carry out an etherification (e.g., etherification reaction). Herein, an addition of an amine derivative is performed in at least one of the alkalization or the etherification.

Hereinafter, each step will be further (e.g., more) illustrated.

First of all, an alkalization (e.g., alkalization reaction) of cellulose and lithium hydroxide is performed. This process (e.g., alkalization reaction) may be performed by mixing cellulose and lithium hydroxide, and the mixing may be performed by physically mixing and/or by an ultrasonic wave.

The alkalization may be carried out in a solvent. The solvent may be water, alcohol, or combinations thereof. The alcohol may be ethanol, isopropyl alcohol, methanol, butanol, or combinations thereof.

Herein, a utilized amount of lithium hydroxide may be about 0.01 parts by weight to about 100 parts by weight, or about 0.1 parts by weight to about 10 parts by weight based on 1 part by weight of the cellulose. The utilized amount of lithium hydroxide within the range, renders to readily undergo (e.g., participate in) a reaction with, or of, cellulose, thereby generating the lithium salt of carboxymethyl cellulose with a substantial amount of conversion (e.g., in higher yield).

Thereafter, the obtained product is mixed with a halogenated (e.g., halogen-including) acetic acid or a salt thereof to carry out etherification (e.g., etherification reaction).

In one or more embodiments, in (e.g., during) at least one of the alkalization or the etherification, an amine derivative may be added. For example, the alkalization may be performed by mixing cellulose, lithium hydroxide, and the amine derivative, or the etherification may be performed by mixing the product (e.g., the resulting alkali product), the halogenated (e.g., halogen-including) acetic acid or a salt thereof, and the amine derivative. Also, the amine derivative may be added in (e.g., during) both the alkalization and the etherification.

As such, the utilization of the amine derivative in the preparation may render to generate (e.g., facilitate generation of) the lithium salt of carboxymethyl cellulose.

The alkali salt of carboxymethyl cellulose is generally prepared by a comparable method of distributing cellulose (i.e., carboxymethyl cellulose) and an alkali hydroxide compound in an alcohol-based solvent such as a mixture of ethanol and water for alkalization, followed by an etherification with a halogenated (e.g., halogen-including) acetic acid or a salt thereof. Alkali salts of carboxymethyl cellulose with sodium salt as the alkali salt are easily prepared by the comparable method, but for conditions where the alkali salt is lithium salt, it is difficult to prepare by the comparable method. Lithium hydroxide has low solubility in the alcohol-based solvent, and thus it does not activate cellulose, thereby causing no etherification. Thus, the typical preparation of the lithium salt of carboxymethyl cellulose is performed by preparing the sodium salt of carboxymethyl cellulose, treating it with an acid and then reacting the resultant neutral product with lithium hydroxide.

On the other hand, the preparation according to one or more embodiments utilizes the amine derivative to omit the preparation of a sodium salt of carboxymethyl cellulose, and directly prepare the lithium salt of carboxymethyl cellulose. This is because even though lithium hydroxide has low solubility in the alcohol-based solvent, the amine derivative may act as a catalyst for etherification, allowing the etherification of unactivated cellulose to readily occur regardless of whether the amine derivative is utilized in any stage of the alkalization or the etherification.

In one or more embodiments, the amine derivative may be represented by Chemical Formula 1 or Chemical Formula 2.

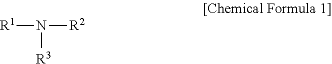

In Chemical Formula 1, R¹, R², and R³ may each independently be the same or different, and are hydrogen, or an unsubstituted or halogen-substituted C1-C12 alkyl group.

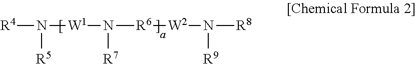

In Chemical Formula 2, R⁴, R⁵, R⁷, R⁸, and R⁹ may each independently be the same or different, and are hydrogen, or an unsubstituted or halogen-substituted C1-C12 alkyl group, R⁶ may a C1-C12 alkenyl group, W¹ and W² may each independently be the same or different and are a C1 to C12 alkenyl group, and a is an integer of about 0 to about 2.

In Chemical Formula 1 or Chemical Formula 2, the alkyl group may be a linear, branched, or cyclic form. In one embodiment, at least one of R¹ to R⁹ may be a C1 to C12 alkyl group, and in another embodiment, all R¹ to R⁹ may be a C1 to C12 alkyl group. If (e.g., when) at least one of R¹ to R⁹ is a C1 to C12 alkyl group, it may have suitable basicity for preparing a lithium salt of carboxymethyl cellulose, so that the side reaction(s) in the reaction may be effectively suppressed or reduced.

In one embodiment, the alkyl group may be a C1 to C4 alkyl group.

The amine derivative according to one embodiment may be dimethylamine, diethylamine, trimethylamine, triethylamine, chloroalkyl amine, bromoalkyl amine, bis(chloro alkyl)amine, tris(chloro alkyl)amine, ethylene diamine, diethylene triamine, triethylene tetraamine, or combinations thereof. In chloroalkyl amine, bromoalkyl amine, bis(chloro alkyl)amine, tris(chloro alkyl)amine, alkyl may be methyl, ethyl, propyl, or butyl.

In one embodiment, an added amount of the amine derivative may be about 0.0001 parts by weight to about 100 parts by weight, or about 0.001 parts by weight to about 10 parts by weight based on about 1 part by weight of the cellulose. If (e.g., when) the added amount of the amine derivative is satisfied in the range, the lithium salt of carboxymethyl cellulose with a suitable degree of lithium substitution for the battery, may be prepared. If (e.g., when) the amine derivative is utilized in an amount of less than 0.0001 parts by weight based on 1 part by weight of the cellulose, the lithium salt of carboxymethyl cellulose may not be effectively prepared.

The halogenated (e.g., halogen-including) acetic acid utilized in the etherification may be chloroacetic acid, fluoroacetic acid, bromoacetic acid, or iodineacetic acid. Furthermore, the halogenated (e.g., halogen-including) acetic acid may be a lithium salt thereof.

An amount of the halogenated (e.g., halogen-including) acetic acid or a salt thereof may be about 0.1 parts by weight to about 100 parts by weight, or about 1 part by weight to about 20 parts by weight based on 1 part by weight of the cellulose. If (e.g., when) the halogenated (e.g., halogen-including) acetic acid or the salt thereof is within the range, the lithium salt of carboxymethyl cellulose with a suitable degree of lithium substitution for the battery, may be prepared.

The degree of lithium substitution refers to a degree of substitution as described further herein.

The degree of substitution (DS) of the lithium salt of carboxymethyl cellulose prepared by the method of one or more embodiments may be about 0.5 or more, and about 1.5 or less, or about 0.7 to about 1.3. The degree of substitution refers to an average number of a substituent group per repeating unit of cellulose that are substituted in cellulose. Thus, the lithium salt of carboxymethyl cellulose according to one embodiment may have three or less CH₂COOLi per the repeating unit of cellulose, i.e., one unit, and may have an average number of about 0.5 or more, and about 1.5 or less.

The lithium salt of carboxymethyl cellulose may have a weight-average molecular weight (Mw) of about 10,000 g/mol to about 10,000,000 g/mol, or about 100,000 g/mol to about 3,000,000 g/mol. If (e.g., when) the weight-average molecular weight (Mw) of the lithium salt carboxymethyl cellulose is within the range, a slurry-type or kind composition with a suitable viscosity for the negative electrode preparation may be prepared, and thus, the processibility may be improved.

In some embodiments, a viscosity of the lithium salt of carboxymethyl cellulose may be about 100 millipascal-second (mPa-s) or more, and about 5000 mPa·s or less in a 1 wt % aqueous solution. The viscosity is the value obtained at a room temperature of about 20° C. to about 25° C.

Such a lithium salt of carboxymethyl cellulose may be appropriately (suitably) utilized in the rechargeable lithium battery, and may be particularly, appropriately utilized as a thickener or a binder.

The negative electrode includes a negative active material layer and a current collector supporting the negative active material layer.

The lithium salt of carboxymethyl cellulose according to one or more embodiments may be included in the negative active material layer. Herein, the amount of lithium salt of carboxymethyl cellulose may be about 0.5 wt % or more, and less than about 3 wt % based on the total, 100 wt % of the negative active material layer.

The negative active material layer may include a negative active material and a binder, and may further include a conductive material.

The negative active material includes a material that reversibly intercalates/deintercalates lithium ions, a lithium metal, a lithium metal alloy, a material capable of doping/dedoping lithium, and/or a transition metal oxide.

The material that reversibly intercalates/deintercalates lithium ions may be a carbon material, and for example, crystalline carbon, amorphous carbon, or a combination thereof. The crystalline carbon may be unspecified shaped, sheet, flake, spherical, and/or fiber shaped natural graphite and/or artificial graphite, and the amorphous carbon may be a soft carbon, a hard carbon, a mesophase pitch carbonization product, fired coke, and/or the like.

The lithium metal alloy includes an alloy of lithium and a metal selected from among Na, K, Rb, Cs, Fr, Be, Mg, Ca, Sr, Si, Sb, Pb, In, Zn, Ba, Ra, Ge, Al, and Sn.

The material capable of doping/dedoping lithium may be a silicon-based material, or a Sn-based negative active material. The Si-based negative active (e.g., the Si-negative (− charge) active) material may be silicon, a Si—C composite, SiOₓ (0<x<2), a Si-Q alloy (wherein Q is an element selected from among an alkali metal, an alkaline-earth metal, a Group 13 element, a Group 14 element, a Group 15 element, a Group 16 element, a transition metal, a rare earth element, and a combination thereof, and not Si), and the Sn-based negative active material may include Sn, SnO₂, a Sn—R alloy (wherein R is an element selected from among an alkali metal, an alkaline-earth metal, a Group 13 element, a Group 14 element, a Group 15 element, a Group 16 element, a transition metal, a rare earth element, and a combination thereof, and not Sn), and/or at least one of these materials may be mixed with SiO₂. The element Q and R may be selected from among Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and combinations thereof.

In one or more embodiments, the Si—C composite may include silicon particles and an amorphous carbon coated on the surface of the silicon particles. For example, the silicon-carbon composite may include a secondary particle in which silicon primary particles are agglomerated and an amorphous carbon coating layer positioned on the surface of the secondary particle. The amorphous carbon is positioned between the silicon primary particles, for example, allowing the silicon primary particles to be coated with amorphous carbon. In some embodiments, the silicon-carbon composite may include a core in which silicon particles are distributed in an amorphous carbon matrix and an amorphous carbon coating layer coated on a surface of the core.

The secondary particles are positioned at the center of the Si—C composite, and thus, it may be referred to as a core or a central part.

In one or more embodiments, the amorphous carbon coating layer may be referred to as an outer part or a shell.

The silicon particles may be nano silicon particles. The nano silicon particles may have a particle diameter of about 10 nanometer (nm) to about 1,000 nm, according to one embodiment, of about 20 nm to about 900 nm, about 20 nm to about 800 nm, about 20 nm to about 500 nm, about 20 nm to about 300 nm, or about 20 nm to about 150 nm. If (e.g., when) the average particle diameter of the Si particle is within the range, the excessive volume expansion caused during charge and discharge may be suppressed or reduced, and a breakage of the conductive path due to crushing of particle during charge and discharge may be prevented or reduced.

Herein, a mixing ratio of the nano silicon and amorphous carbon may be about 1:99 to about 60:40 weight ratio.

In one or more embodiments, the secondary particle or the core may further include crystalline carbon. In some embodiments, if (e.g., when) the silicon-carbon composite further includes the crystalline carbon, the Si—C composite may include a secondary particle in which the silicon primary particles and the crystalline carbon are agglomerated, and an amorphous carbon coating layer positioned on the surface of the secondary particle.

In one or more embodiments, if (e.g., when) the Si—C includes the silicon particle, the crystalline carbon and the amorphous carbon, an amount of the amorphous carbon may be about 30 wt % to 70 wt % based on the total 100 wt % of the Si—C composite, and an amount of the crystalline carbon may be about 1 wt % to about 20 wt % based on the total 100 wt %, of the Si—C composite. In some embodiments, an amount of the silicon particles may be about 20 wt % to about 70 wt % based on the total 100 wt % of the Si—C composite, or according to one embodiment, about 30 wt % to about 60 wt % based on the total 100 wt % of the Si—C composite.

The particle diameter of the Si—C composite may be appropriately controlled or selected, and there is no need to limit it.

If (e.g., when) the amorphous carbon is positioned by around (e.g., surrounding) the surface of the secondary particles surface, a thickness thereof may be suitably controlled or selected, but, for example, may be about 5 nm to about 100 nm.

In one or more embodiments, the Si—C composite may be included as a first negative active material and a crystalline carbon may be included as a second negative active material. Herein, a mixing ratio of the first negative active material and the second negative active material may be about 1:99 to about 50:50 by weight ratio. In one or more embodiments, the negative active material may also include the first negative active material and the second negative active material at a weight ratio of about 5:95 to about 20:80.

The binder improves binding properties of negative active material particles with one another and with a current collector. The binder may be an aqueous binder.

The aqueous binder may be a styrene-butadiene rubber, an acrylated styrene-butadiene rubber (ABR), an acrylonitril-butadiene rubber, an acryl rubber, a butyl rubber, a fluorine rubber, an ethylene oxide containing polymer, polyvinyl pyrrolidone, polypropylene, polyepichlorohydrine, polyphosphazene, an ethylene propylenediene copolymer, polyvinylpyridine, chlorosulfonated polyethylene, latex, a polyester resin, an acryl resin, a phenol resin, an epoxy resin, polyvinyl alcohol, or one or more combinations thereof.

An amount of the aqueous binder may be about 0.5 wt % or more and less than about 3 wt % based on the total 100 wt % of the negative active material layer. According to one or more embodiments, the total amount of the lithium salt of carboxymethyl cellulose and the aqueous binder may be about 1 wt % to about 3 wt % based on the total, 100 wt % of the negative active material layer.

The conductive material is included to provide electrode conductivity, and any electrically conductive material may be utilized as a conductive material unless it causes a chemical change. Examples of the conductive material may be a carbon-based material such as natural graphite, artificial graphite, carbon black, acetylene black, ketjen black, carbon fiber, and/or the like; a metal-based material of a metal powder or a metal fiber including copper, nickel, aluminum, silver, and/or the like; a conductive polymer such as a polyphenylene derivative; or a mixture thereof.

The current collector may include one selected from among a copper foil, a nickel foil, a stainless steel foil, a titanium foil, a nickel foam, a copper foam, a polymer substrate coated with a conductive metal, and a combination thereof, but is not limited thereto.

A rechargeable lithium battery according to one or more embodiments includes the negative electrode, a positive electrode, and an electrolyte.

The positive electrode includes a current collector and a positive active material layer formed on the current collector.

The positive active material may include lithiated intercalation compounds that reversibly intercalate and deintercalate lithium ions. For example, one or more composite oxides of a metal selected from among cobalt, manganese, nickel, and a combination thereof, and lithium, may be utilized. For more examples, the compounds represented by one selected from among the following chemical formulae may be utilized. LiₐA_{1-b}X_{b}D¹₂ (0.90≤a≤1.8, 0≤b≤0.5); LiₐA_{1-b}X_{b}O_{2-c1}D¹_{c1} (0.90≤a≤1.8, 0≤b≤0.5, 0≤c1≤0.05); LiₐE_{1-b}X_{b}O_{2-c1}D¹_{c1} (0.90≤a≤1.8, 0≤b≤0.5, 0≤c1≤0.05); LiₐE_{2-b}X_{b}O_{4-c1}D¹_{c1} (0.90≤a≤1.8, 0≤b≤0.5, 0≤c1≤0.05); LiₐNi_{1-b-c}CO_{b}X_{c}D¹_{α} (0.90≤a≤1.8, 0≤b≤0.5, 0≤c≤0.5, 0<α≤2); LiₐNi_{1-b-c}CO_{b}X_{c}O_{2-α}T_{α} (0.90≤a≤1.8, 0≤b≤0.5, 0≤c≤0.5, 0<α<2); LiₐNi_{1-b-c}CO_{b}X_{c}O_{2-α}T₂ (0.90≤a≤1.8, 0≤b≤0.5, 0≤c≤0.5, 0<α<2); LiₐNi_{1-b-c}Mn_{b}X_{c}D¹_{α} (0.90≤a≤1.8, 0≤b≤0.5, 0≤c≤0.5, 0<a≤2); LiₐNi_{1-b-c}Mn_{b}X_{c}O_{2-α}T_{α} (0.90≤a≤1.8, 0≤b≤0.5, 0≤c≤0.5, 0<α<2); LiₐNi_{1-b-c}Mn_{b}X_{c}O_{2-α}T₂ (0.90≤a≤1.8, 0≤b≤0.5, 0≤c≤0.5, 0<α<2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1) LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li_{(3-f)}J₂(PO₄)₃ (0≤f≤2); Li_{(3-f)}Fe₂(PO₄)₃ (0≤f≤2); and/or LiₐFePO₄ (0.90≤a≤1.8)

In the above chemical formulae, A is selected from among Ni, Co, Mn, and a combination thereof; X is selected from among Al, Ni, Co, Mn, Cr, Fe, Mg, Sr, V, a rare earth element, and a combination thereof; D¹ is selected from among O, F, S, P, and a combination thereof; E is selected from among Co, Mn, and a combination thereof; T is selected from among F, S, P, and a combination thereof; G is selected from among Al, Cr, Mn, Fe, Mg, La, Ce, Sr, V, and a combination thereof; Q is selected from among Ti, Mo, Mn, and a combination thereof; Z is selected from among Cr, V, Fe, Sc, Y, and a combination thereof; J is selected from among V, Cr, Mn, Co, Ni, Cu, and a combination thereof; and L¹ is selected from among Mn, Al and combinations thereof.

In one or more embodiments, the compounds may have a coating layer on the surface, or may be mixed with another compound having a coating layer. The coating layer may include at least one coating element compound selected from among the group consisting of an oxide of a coating element, a hydroxide of a coating element, an oxyhydroxide of a coating element, an oxycarbonate of a coating element, and a hydroxyl carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed in a method having no adverse influence on properties of a positive electrode active material by utilizing these elements in the compound, and for example, the method may include any coating method such as spray coating, dipping, and/or the like, but is not illustrated in more detail because it is well-suitable in the related field.

In the positive electrode, an amount of the positive active material may be about 90 wt % to about 98 wt % based on the total weight of the positive active material layer.

In one or more embodiments, the positive active material layer may further include a binder and a conductive material. Herein, the amount of the binder and the conductive material may be about 1 wt % to about 5 wt %, respectively based on the total amount of the positive active material layer.

The binder improves binding properties of positive electrode active material particles with one another and with a current collector. The examples of the binder may be polyvinyl alcohol, carboxymethyl cellulose, hydroxypropyl cellulose, diacetylcellulose, polyvinyl chloride, carboxylated polyvinyl chloride, polyvinyl fluoride, an ethylene oxide-containing polymer, polyvinyl pyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and/or the like, but is not limited thereto.

The conductive material is included to provide electrode conductivity, and any electrically conductive material may be utilized as a conductive material unless it causes a chemical change. Examples of the conductive material may be a carbon-based material such as natural graphite, artificial graphite, carbon black, acetylene black, ketjen black, carbon fiber, and/or the like; a metal-based material of a metal powder or a metal fiber including copper, nickel, aluminum, silver, and/or the like; a conductive polymer such as a polyphenylene derivative; or a mixture thereof.

The current collector may be Al, but is not limited thereto.

The electrolyte includes a non-aqueous organic solvent and a lithium salt.

The non-aqueous organic solvent serves as a medium for transmitting ions taking part in the electrochemical reaction of a battery.

The non-aqueous organic solvent may include a carbonate-based, ester-based, ether-based, ketone-based, alcohol-based, or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. The ester-based solvent may include methyl acetate, ethyl acetate, n-propyl acetate, dimethyl acetate, methyl propionate, ethyl propionate, decanolide, mevalonolactone, caprolactone, and/or the like. The ether-based solvent may be dibutyl ether, tetraglyme, diglyme, dimethoxyethane, 2-methyltetrahydrofuran, tetrahydrofuran, and/or the like. Furthermore, the ketone-based solvent may be cyclohexanone, and/or the like. The alcohol-based solvent may include ethyl alcohol, isopropyl alcohol, and/or the like, and examples of the aprotic solvent may include nitriles such as R—CN (where R is a C2 to C20 linear, branched, or cyclic hydrocarbon, or may include a double bond, an aromatic ring, or an ether bond), amides such as dimethylformamide, dioxolanes such as 1,3-dioxolane, sulfolanes, and/or the like.

The organic solvent may be utilized alone or in a mixture. If (e.g., when) the organic solvent is utilized in a mixture, the mixture ratio may be controlled or selected in accordance with a desirable battery performance, and it is well suitable in one of ordinary skilled in the art.

In one or more embodiments, the carbonate-based solvent may desirably utilize a mixture with a cyclic carbonate and a linear carbonate. The cyclic carbonate and linear carbonate are mixed together in a volume ratio of about 1:1 to about 1:9, and if (e.g., when) the mixture is utilized as an electrolyte, it may have enhanced performance.

The non-aqueous organic solvent may further include an aromatic hydrocarbon-based solvent as well as the carbonate-based solvent. Herein, the carbonate-based solvent and the aromatic hydrocarbon-based solvent may be mixed together in a volume ratio of about 1:1 to about 30:1.

The aromatic hydrocarbon-based organic solvent may be an aromatic hydrocarbon-based compound represented by Chemical Formula.

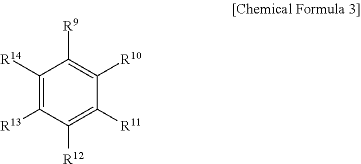

In Chemical Formula 3, R⁹ to R¹⁴ may each independently be the same or different and are selected from among hydrogen, a halogen, a C1 to C10 alkyl group, a haloalkyl group, and a combination thereof.

Some examples of the aromatic hydrocarbon-based organic solvent may be selected from among benzene, fluorobenzene, 1,2-difluorobenzene, 1.3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and combinations thereof.

The electrolyte may further include vinylethyl carbonate, vinylene carbonate, or an ethylene carbonate-based compound represented by Chemical Formula 4, as an additive for improving cycle life.

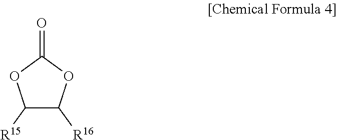

In Chemical Formula 4, R¹⁵ and R¹⁶ may each independently be the same or different and may each independently be hydrogen, a halogen, a cyano group (CN), a nitro group (NO₂), or a C1 to C5 fluoroalkyl group, provided that at least one of the of R¹⁵ and R¹⁶ is a halogen, a cyano group (CN), a nitro group (NO₂), or a C1 to C5 fluoroalkyl group, and R¹⁵ and R¹⁶ are not concurrently (e.g., simultaneously) hydrogen.

Examples of the ethylene carbonate-based compound may be difluoro ethylene carbonate, chloroethylene carbonate, dichloroethylene carbonate, bromoethylene carbonate, dibromoethylene carbonate, nitroethylene carbonate, cyanoethylene carbonate or fluoroethylene carbonate, and/or the like. An amount of the additive for improving the cycle-life characteristics may be utilized within an appropriate or suitable range.

The lithium salt dissolved in an organic solvent supplies a battery with lithium ions, suitably operates the rechargeable lithium battery, and improves transportation of the lithium ions between a positive electrode and a negative electrode. Examples of the lithium salt include at least one supporting salt selected from among LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide: LiFSI), LiC₄F₉SO₃, LiClO₄, LiAlO₂, LiAlCl₄, LIPO₂F₂, LiN(CₓF₂ₓ₊₁SO₂)(C_{y}F_{2y+1}SO₂), where x and y are natural numbers, for example, an integer of about 1 to about 20, lithium difluoro(bisoxolato) phosphate), LiCl, LiI, LiB(C₂O₄)₂ (lithium bis(oxalato) borate: LiBOB) and lithium difluoro(oxalato)borate (LiDFOB). A concentration of the lithium salt may range from about 0.1 M to about 2.0 M. If (e.g., when) the lithium salt is included at the above concentration range, an electrolyte may have excellent or suitable performance and lithium ion mobility due to optimal or suitable electrolyte conductivity and viscosity.

A separator may be disposed between the positive electrode and the negative electrode depending on a type or kind of a rechargeable lithium battery. Examples of a suitable separator material may include polyethylene, polypropylene, polyvinylidene fluoride, and multi-layers thereof such as a polyethylene/polypropylene double-layered separator, a polyethylene/polypropylene/polyethylene triple-layered separator, and a polypropylene/polyethylene/polypropylene triple-layered separator.

The drawing is a perspective view of a rechargeable lithium battery according to one or more embodiments. The rechargeable lithium battery according to one or more embodiments is illustrated as a prismatic battery but is not limited thereto, and may include variously-(suitable) shaped batteries such as a cylindrical battery, a pouch battery, and/or the like.

Referring to the drawing, a rechargeable lithium battery 100 according to one or more embodiments includes an electrode assembly 40 manufactured by winding a separator 30 interposed between a positive electrode 10 and a negative electrode 20, and a case 50 housing the electrode assembly 40. An electrolyte may be impregnated in the positive electrode 10, the negative electrode 20, and the separator 30.

Terms such as “substantially,” “about,” and “approximately” are used as relative terms and not as terms of degree, and are intended to account for the inherent deviations in measured or calculated values that would be recognized by those of ordinary skill in the art. They may be inclusive of the stated value and an acceptable range of deviation as determined by one of ordinary skill in the art, considering the limitations and error associated with measurement of that quantity. For example, “about” may refer to one or more standard deviations, or +30%, 20%, 10%, 5% of the stated value.

Numerical ranges disclosed herein include and are intended to disclose all subsumed sub-ranges of the same numerical precision. For example, a range of “1.0 to 10.0” includes all subranges having a minimum value equal to or greater than 1.0 and a maximum value equal to or less than 10.0, such as, for example, 2.4 to 7.6. Applicant therefore reserves the right to amend this specification, including the claims, to expressly recite any sub-range subsumed within the ranges expressly recited herein.

Hereinafter, examples of the present disclosure and comparative examples are described. These examples are not in any sense to be interpreted as limiting the scope of the present disclosure.

### EXAMPLES

### Example 1

Cellulose was mixed with lithium hydroxide in a water solvent utilizing a mechanical stirrer to carry out an alkalization, thereby preparing an alkali product.

To the alkali product, chloroacetic acid and triethylamine were added to carry out etherification.

In the process, a weight ratio of cellulose, chloroacetic acid, and triethylamine was set to be 1:1:5. A utilized amount of lithium hydroxide was 5 parts by weight based on 1 part by weight of cellulose.

According to the process, a lithium salt of carboxymethyl cellulose with a degree of substitution of 0.5 was prepared (yield: 98%). An aqueous solution having 1 wt % of the prepared product had a viscosity (at 25° C.) of 5000 mPas, and the lithium salt of carboxymethyl cellulose had a weight-average molecular weight (Mw) of 100,000 g/mol to 1,000,000 g/mol.

### Example 2

A lithium salt of carboxymethyl cellulose with a degree of substitution of 0.9 was prepared (yield: 98%) by the same procedure as in Example 1, except that the weight ratio of cellulose, chloroacetic acid, and triethylamine was changed to 1:2:5.

An aqueous solution having 1 wt % of the prepared product had a viscosity (at 25° C.) of 3000 mPas, and the lithium salt of carboxymethyl cellulose had a weight-average molecular weight (Mw) of 100,000 g/mol to 1,000,000 g/mol.

### Example 3

A lithium salt of carboxymethyl cellulose with a degree of substitution of 1.2 was prepared (yield: 94%) by the same procedure as in Example 1, except that the weight ratio of cellulose, chloroacetic acid, and triethylamine was changed to 1:5:5.

An aqueous solution having 1 wt % of the prepared product had a viscosity (at 25° C.) of 1500 mPas, and the lithium salt of carboxymethyl cellulose had a weight-average molecular weight (Mw) of 100,000 g/mol to 1,000,000 g/mol.

### Example 4

A lithium salt of carboxymethyl cellulose with a degree of substitution of 1.5 was prepared (yield: 91%) by the same procedure as in Example 1, except that the weight ratio of cellulose, chloroacetic acid, and triethylamine was changed to 1:5:10.

An aqueous solution having 1 wt % of the prepared product had a viscosity (at 25° C.) of 100 mPas, and the lithium salt of carboxymethyl cellulose had a weight-average molecular weight (Mw) of 100,000 g/mol to 1,000,000 g/mol.

### Comparative Example 1

Cellulose was mixed with lithium hydroxide in a water solvent utilizing a mechanical stirrer to carry out an alkalization, thereby preparing an alkali product.

To the alkali product, chloroacetic acid was added to carry out etherification, thereby preparing a lithium salt of carboxymethyl cellulose with a degree of substitution of 0.4 (yield: 5%).

In the process, a weight ratio of cellulose and chloroacetic acid was set to be 1:10. The prepared lithium salt of carboxymethyl cellulose had too low solubility in water and the viscosity therefor was unable measured.

### (Experimental Example 1) Measurement of a Degree of Substitution

For the lithium salt of carboxymethyl cellulose according to Examples 1 to 4 and Comparative Example 1, the degree of lithium substitution was measured via an ICP (Inductively-coupled plasma) analysis. The results are shown in Table 1.

### (Experimental Example 2) Measurement of Amount of Lithium

The amount of lithium included in the lithium salt of carboxymethyl cellulose according to Examples 1 to 4 and Comparative Example 1 was measured via an ICP analysis. The results are shown in Table 1.

The weight ratio of cellulose, chloroacetic acid (CA), and triethylamine (TEA), yield, and viscosity according to Examples 1 to 4 and Comparative Example 1 are also summarized in Table 1, where “DS” indicates degree of substitution.

TABLE 1

| | | | | | Viscosity |
|---|---|---|---|---|---|
| | Cellulose/CA/TEA | | Li Amount | | 1 wt % aq. solution |
| | (weight ratio) | DS | (mass %) | Yield (%) | (mPa-s) |
| Example 1 | 1/1/5 | 0.5 | 1.78 | 98 | 5000 |
| Example 2 | 1/2/5 | 0.9 | 2.83 | 98 | 3000 |
| Example 3 | 1/5/5 | 1.2 | 3.47 | 94 | 1500 |
| Example 4 | 1/5/10 | 1.5 | 4.02 | 91 | 100 |
| Comparative | 1/10/0 | 0.4 | 1.48 | 5 | Not measurable |
| Example 1 | | | | | |

As shown in Table 1, Examples 1 to 4 in which lithium salts of carboxymethyl cellulose were prepared utilizing the amine derivative, prepared the lithium salts of carboxymethyl cellulose having the suitable degree of substitution with a high yield. On the other hand, Comparative Example 1 without the amine derivative prepared carboxymethyl cellulose having a low degree of substitution at an extremely low yield.

While this disclosure has been described in connection with what is presently considered to be practical example embodiments, it is to be understood that the present disclosure is not limited to the disclosed embodiments, but, on the contrary, is intended to cover one or more suitable modifications and equivalent arrangements included within the spirit and scope of the appended claims and equivalents thereof.

What is claimed is:

1. A method of preparing a lithium salt of carboxymethyl cellulose, the method comprising:
carrying out alkalization of cellulose and lithium hydroxide to form a resulting product; and
mixing the resulting product with a halogenated acetic acid or a salt thereof to carry out etherification,
wherein an amine derivative is added into the alkalization and/or the etherification.

2. The method as claimed in claim 1, wherein the amine derivative is represented by Chemical Formula 1 or Chemical Formula 2; 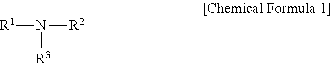
wherein, in Chemical Formula 1, R¹, R², and R³ are the same or different, and are each hydrogen, or an unsubstituted or halogen-substituted C1-C12 alkyl group; 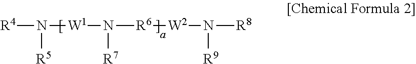
in Chemical Formula 2, R⁴, R⁵, R⁷, R⁸, and R⁹ are the same or different, and are each hydrogen, or an unsubstituted or halogen-substituted C1-C12 alkyl group,
R⁶ is a C1-C12 alkenyl group,
W¹ and We are the same or different and are each a C1 to C12 alkenyl group, and
a is an integer of about 0 to about 2.

3. The method as claimed in claim 1, wherein the amine derivative is dimethylamine, diethylamine, trimethylamine, triethylamine, chloroalkyl amine, bromoalkyl amine, bis(chloro alkyl)amine, tris(chloro alkyl)amine, ethylene diamine, diethylene triamine, triethylene tetraamine, or one or more combinations thereof.

4. The method as claimed in claim 1, wherein the halogenated acetic acid is chloroacetic acid, fluoroacetic acid, bromoacetic acid, iodineacetic acid, or one or more combinations thereof.

5. The method as claimed in claim 1, wherein the salt of the halogenated acetic acid is a lithium salt of a halogenated acetic acid.

6. The method as claimed in claim 1, wherein an added amount of the amine derivative is 0.0001 parts by weight to 100 parts by weight based on 1 part by weight of the cellulose.

7. The method as claimed in claim 1, wherein the halogenated acetic acid or the salt thereof is added at an amount of about 0.1 parts by weight to about 100 parts by weight based on 1 part of the cellulose.

8. The method as claimed in claim 1, wherein the lithium salt of carboxymethyl cellulose has a degree of substitution of about 0.5 or more and about 1.5 or less.

9. The method as claimed in claim 1, wherein the alkalization is carried out in a solvent.

10. The method as claimed in claim 9, wherein the solvent is water, alcohol, or a combination thereof.

11. A rechargeable lithium battery, comprising:
a negative electrode comprising the lithium salt of carboxymethyl cellulose prepared by the method as claimed in claim 1;
a positive electrode; and
an electrolyte.
